(19) United States
(12) Patent Application Publication
(10) Pub. No.: US 2018/0025356 A1
(43) Pub. Date: Jan. 25, 2018

(54) COMPUTER DEVICE FOR MONITORING FOR FRAUDULENT ACTIVITY

(71) Applicant: MasterCard Asia/Pacific Pte. Ltd., Singapore (SG)

(72) Inventors: Rajat Maheshwari, Singapore (SG); Frederic Fortin, Brussels (BE); Vijin Venugopalan, Singapore (SG)

(21) Appl. No.: 15/652,917

(22) Filed: Jul. 18, 2017

(30) Foreign Application Priority Data
Jul. 22, 2016 (SG) 10201606033Y

(51) Int. Cl. G06Q 20/40

(52) U.S. Cl. CPC G06Q 20/4016

(57) ABSTRACT

A computer device for monitoring for fraudulent activity, including (a) a plurality of sensors; and (b) one or more processors in communication with the sensors and non-transitory data storage including, stored thereon, a plurality of instructions which, when executed, cause the one or more processors to perform the steps of (i) receiving instructions to determine a confidence level; (ii) determining a confidence level by monitoring one or more of the following: sensor data; user behaviour; payment history; security level; connected devices; and location data; and (iii) returning said confidence level, wherein the confidence level represents a relative risk of fraudulent activity.

### FIELD OF THE INVENTION

The present invention relates to a computer device for monitoring for fraudulent activity.

### BACKGROUND OF INVENTION

The complete payment industry is transforming from analog to digital. As a result of this process, payment cards (such as credit cards, debit cards and prepaid cards) are being digitized and stored on mobile devices.

Mobile devices typically includes a number of user authentication procedures employed when accessing services (such as digital wallets, websites, networks, applications, etc) and devices (such as smartphones, computers, etc.). Commonly deployed authentication methods include:
(a) password authentication;
(b) Iris authentication;
(c) Facial authentication;
(d) Voice authentication;
(e) Fingerprint authentication;
(f) Vein authentication; and
(g) Predetermined gestures.

Each of the above-mentioned authentication procedures has its relative strengths and weaknesses for security, reliability and/or implementation.

The above authentication procedures provide a basic means of authenticating procedures. However, these techniques may not provide the means to monitor multiple sources of information to determine a risk level (also referred to as a confidence level) associated with a current authentication procedure. For example, the above authentication procedures may not necessarily take into account that the present situation in which an authentication request has been made has a heightened risk level as a result of circumstances extraneous to the transaction itself. As such, current authentication techniques may allow the user to use an authentication procedure that has a lower inherent security level.

Security flaws in mobile products can lead:
(a) fraud losses;
(b) brand damage; and
(c) potential to kill mobile payments.

It is generally desirable to reduce or mitigate fraud in financial transactions and to enhance user experience.

It is generally desirable to assess a risk level associated with an authentication procedure before proceeding with the authentication procedure.

It is generally desirable to overcome or ameliorate one or more of the above described difficulties, or to at least provide a useful alternative.

### SUMMARY OF INVENTION

In accordance with the invention, there is also provided, a computer device for monitoring for fraudulent activity, including:
(a) a plurality of sensors; and
(b) one or more processors in communication with the sensors and non-transitory data storage including, stored thereon, a plurality of instructions which, when executed, cause the one or more processors to perform the steps of:
   (i) receiving instructions to determine a confidence level;
   (ii) determining a confidence level by monitoring one or more of the following:
      sensor data;
      user behaviour;
      payment history;
      security level;
      connected devices; and
      location data; and
   (iii) returning said confidence level,
wherein the confidence level represents a relative risk of fraudulent activity.

Preferably, the step of monitoring connected devices includes the steps of determining if a separate device is in communication with the computer device, then decrementing the confidence level if there is a reduction of the quality of the signals received from the separate device.

Preferably, the step of monitoring user behaviour includes the step of decrementing the confidence level if the user is not following normal behaviour patterns.

In accordance with the invention, there is also provided a method for monitoring for fraudulent activity on a computer device, including:
(a) receiving an instruction to determine a confidence level;
(b) determining a confidence level by monitoring one or more of the following:
   (i) sensor data;
   (ii) user behaviour;
   (iii) payment history;
   (iv) security level;
   (v) connected devices; and
   (vi) location data; and
(c) returning said confidence level,
wherein the confidence level represents a relative risk of fraudulent activity.

Preferably, the step of monitoring connected devices includes the steps of determining if a separate device is in communication with the computer device, then decrementing the confidence level if there is a reduction of the quality of the signals received from the separate device.

In accordance with the invention there is also provided a computer device for effecting an authentication procedure associated with a computer device for effecting an authentication procedure associated with a service provider or an application, including:
(a) a plurality of sensors; and
(b) one or more processors in communication with the sensors and non-transitory data storage including, stored thereon, a plurality of instructions which, when executed, cause the one or more processors to perform the steps of:
   (i) receiving an authentication procedure request;
   (ii) determining a confidence level associated with the procedure;
   (iii) selecting an authentication procedure available on the device that matches said confidence level; and
   (iv) executing the selected authentication procedure.

Preferably, each authentication procedure on the device has an associated confidence level.

Preferably, the step of determining the confidence level includes the steps of:
(a) determining if a separate device was in communication with the computer device during a previous authentication procedure;
(b) determining if said separate device is currently in communication with the computer device and, if so, incrementing the confidence level.

Preferably, if the authentication procedure relates to an in App purchase, then the step of determining the confidence level includes the steps of determining if the procedure is being effected from secure location and, if so, incrementing the confidence level.

Preferably, if the authentication procedure relates to an in Store purchase, then the step of determining the confidence level includes the steps of incrementing the confidence level if the procedure relates to a repeat purchase.

Preferably, the step of determining the confidence level is determined based on device security level. Alternatively, the step of determining the confidence level is determined based on user behaviour.

In accordance with the invention, there is also provided a method for effecting an authentication procedure associated with a service provider or an application, including the steps of:
(a) receiving an authentication procedure request;
(b) determining a confidence level of the authentication procedure;
(c) selecting an authentication procedure available on the device that matches the confidence level; and
(d) executing the selected authentication procedure.

Preferably, each authentication procedure on the device has an associated confidence level.

Preferably, the step of determining the confidence level includes the steps of:
(a) determining if a separate device was in communication with the computer device during a previous authentication procedure;
(b) determining if said separate device is currently in communication with the computer device and, if so, incrementing the confidence level.

Preferably, if the authentication procedure relates to an in App purchase, then the step of determining the confidence level includes the steps of determining if the procedure is being effected from secure location and, if so, incrementing the confidence level.

Preferably, if the authentication procedure relates to an in Store purchase, then the step of determining the confidence level includes the steps of incrementing the confidence level if the procedure relates to a repeat purchase.

Preferably, the step of determining the confidence level is determined based on device security level. Alternatively, the step of determining the confidence level is determined based on user behaviour.

Advantageously, the above-described method cause the computer device to select an authentication procedure that matches the current confidence level of the transaction.

### BRIEF DESCRIPTION OF THE DRAWINGS

Preferred embodiments of the invention are hereafter described, by way of non-limiting example only, with reference to the accompanying drawings, in which:

FIG. 1a is a schematic diagram of a device on which preferred embodiments of the invention are implemented;

FIG. 1b is a diagrammatic illustration of the device shown in FIG. 1a;

FIG. 2 is a flow diagram showing steps performed by an authentication procedure that calls on a fraud engine top determine a confidence level;

FIG. 3 is a schematic diagram showing inputs and outputs of the fraud engine used to implement processing steps shown in FIG. 2;

FIG. 4 is a flow diagram showing steps performed by the engine shown in FIG. 3;

FIG. 5 is a flow diagram showing further steps performed by the engine shown in FIG. 3;

FIG. 6 is a flow diagram showing further steps performed by the engine shown in FIG. 3; and

FIG. 7 is a flow diagram showing further steps performed by the engine shown in FIG. 3.

### DETAILED DESCRIPTION OF PREFERRED EMBODIMENTS OF THE INVENTION

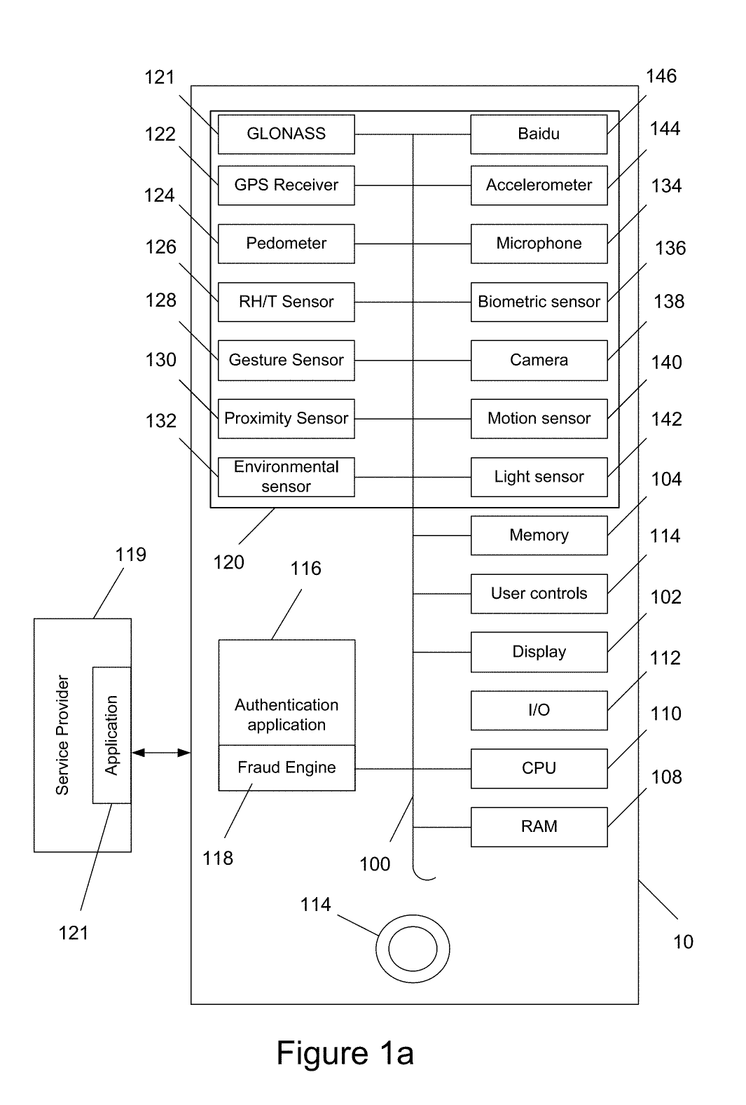

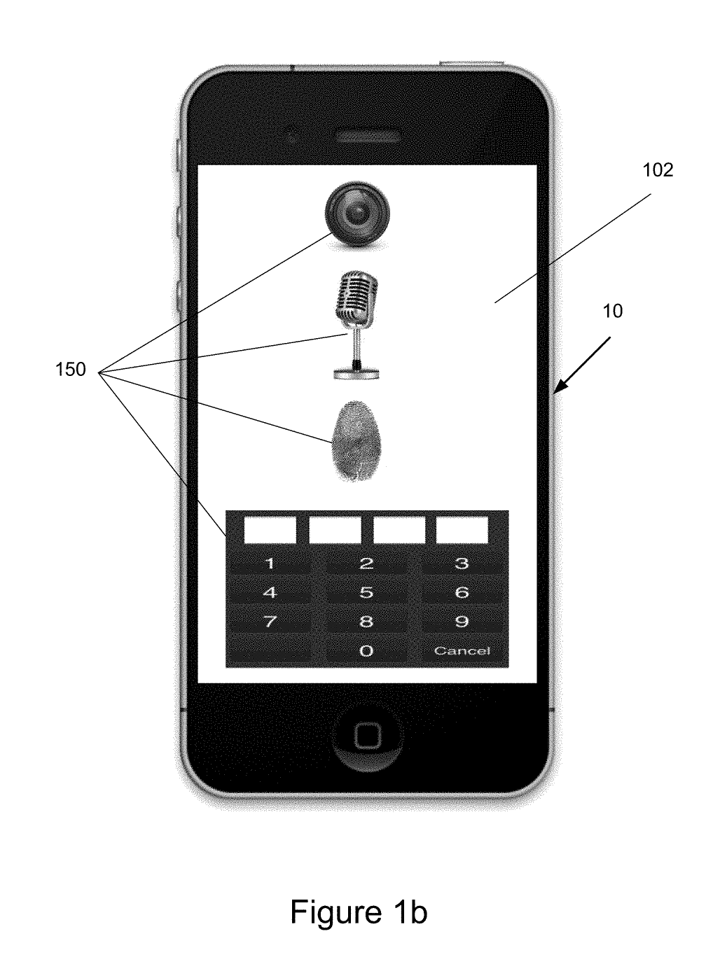

FIG. 1a is a block diagram showing an exemplary device 10 in which embodiments of the invention may be practiced. The device 10 is preferably a mobile device that is any form of programmable computer device including but not limited to laptop computers, tablets, smartphones, televisions, desktop computers, home appliances, cellular telephones, personal television devices, personal data assistants (PDA's), palm-top computers, wireless electronic mail receivers, multimedia Internet enabled cellular telephones, wireless gaming controllers, receivers within vehicles (e.g., automobiles), interactive game devices, notebooks, smartbooks, netbooks, mobile television devices, or any computing device or data processing apparatus. For ease of description, the device 10 is below described, by way of non-limiting example, with reference to a mobile device in the form of a smart phone such as the one shown in FIG. 1b or one manufactured by LG™, HTC™ and Samsung.

As shown, the device 10 includes the following components in electronic communication via a bus 100:
1. a display 102;
2. non-volatile (non-transitory) memory 104;
3. random access memory (“RAM”) 108;
4. N processing components 110;
5. a transceiver component 112 that includes N transceivers; and
6. user controls 114.

Although the components depicted in FIG. 1a represent physical components, FIG. 1a is not intended to be a hardware diagram. Thus, many of the components depicted in FIG. 1a may be realized by common constructs or distributed among additional physical components. Moreover, it is certainly contemplated that other existing and yet-to-be developed physical components and architectures may be utilized to implement the functional components described with reference to FIG. 1a.

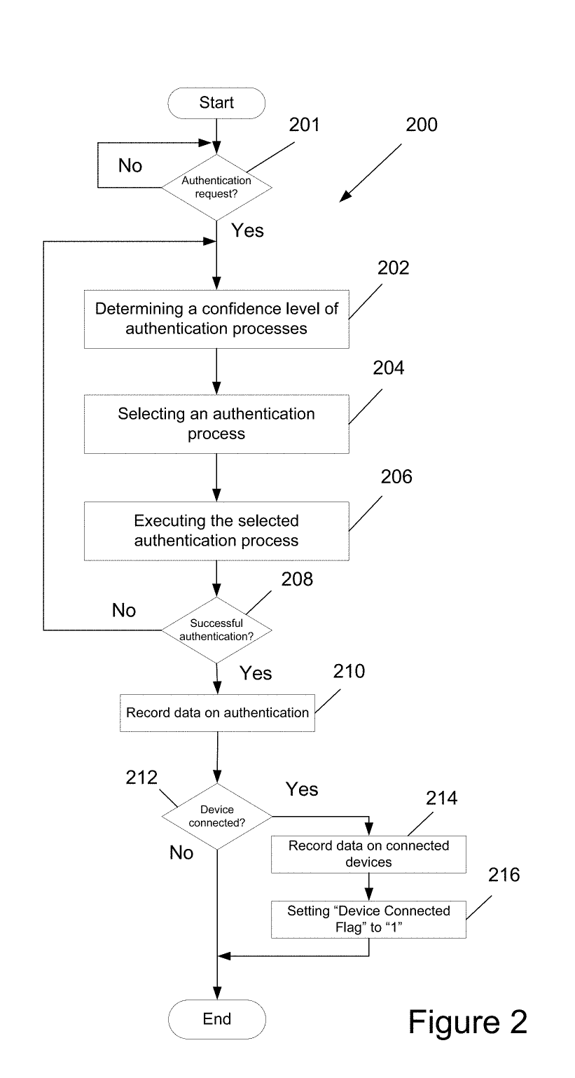

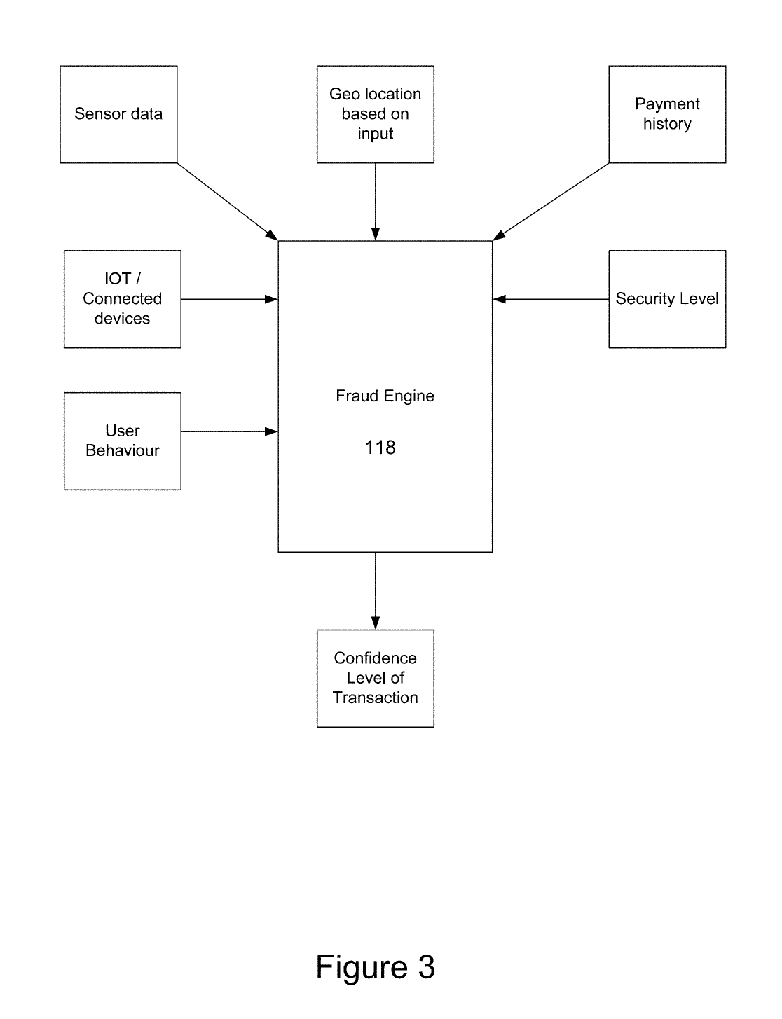

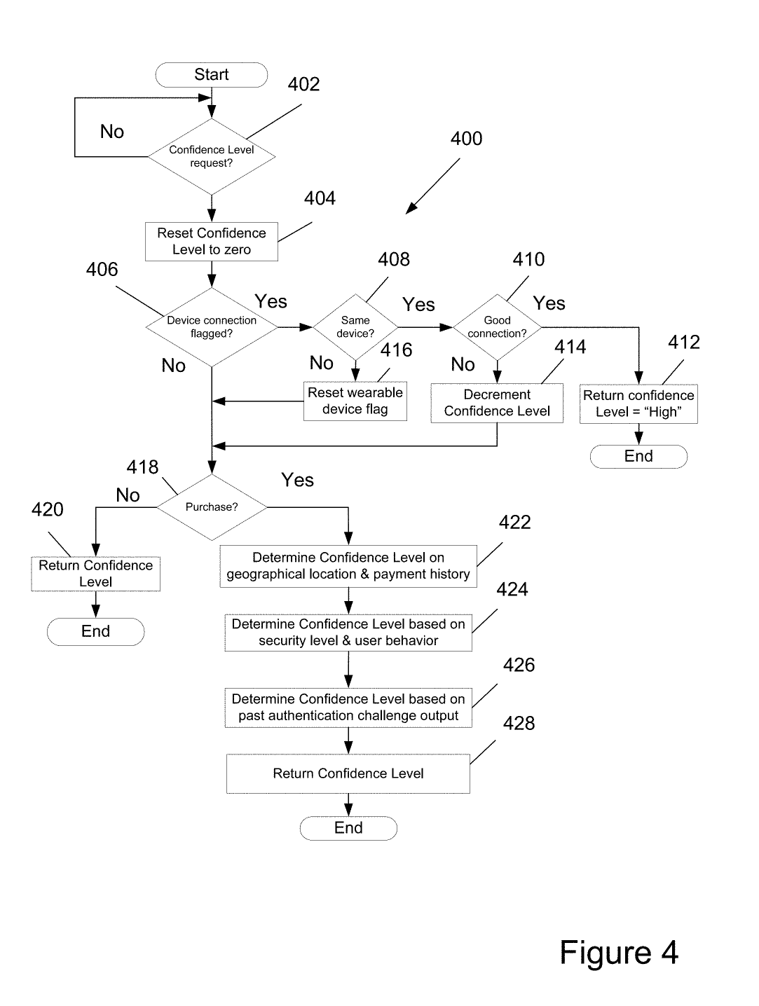

The display 102 generally operates to provide a presentation of content to a user, and may be realized by any of a variety of displays (e.g., CRT, LCD, HDMI, micro-projector and OLED displays). In general, the non-volatile data storage 104 (also referred to as non-volatile memory) functions to store (e.g., persistently store) data and executable code including code that is associated with the functional components of an Authentication Application 116 that executes the processes 200 set out in FIG. 2 and an Fraud Engine 118 configured in the manner shown in FIG. 3 to execute the processes 400 shown in FIG. 4.

In some embodiments for example, the non-volatile memory 104 includes bootloader code, modem software, operating system code, file system code, and code to facilitate the implementation of one or more portions of the Authentication Application 116 and the Fraud Engine 118 as well as other components, well known to those of ordinary skill in the art, that are not depicted nor described for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components 110 in connection with RAM 108 generally operate to execute the instructions stored in non-volatile memory 104. As one of ordinarily skill in the art will appreciate, the N processing components 110 may include a video processor, modem processor, DSP, graphics processing unit (GPU), and other processing components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

It should be recognized that FIG. 1a is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 104. Non-transitory computer-readable media 104 includes both computer storage media and communication media including any medium that facilitates transfer of a computer program from one place to another. A storage media may be any available media that can be accessed by a computer.

The device 10 also includes one or more of the sensors 120 in electronic communication with the CPU 110 via a bus 100. In the example shown, the device 10 includes the following:
1. GLONASS 121;
2. GPS Receiver 122;
3. Pedometer 124;
4. Relative humidity and temperature (RH/T) Sensor 126;
5. Gesture sensor 128;
6. Proximity sensor 130;
7. Environmental sensor 132;
8. Microphone 134;
9. Biometric sensor 136;
10. Camera 138;
11. Motion sensor 140;
12. Light sensor 142;
13. accelerometer 144; and
14. Baidu 146.

Although not shown in FIG. 1a, the device 10 may also include sensors 120 such as:
1. a clock;
2. a gyroscope;
3. magnetometer;
4. orientation sensor;
5. fingerprint sensor;
6. infrared sensor;
7. near field communication sensor;

An exemplary embodiment of the device 10 is shown in FIG. 1b. As shown, the device 10 includes a display 102 showing icons 150 for authentication and a window 152 indicating access type.

### Authentication Application 116

With reference to FIG. 2, the mobile device 10 executes the Authentication Application for an authentication procedure associated with a service provider or an application by performing the steps 200, including:
(a) receiving an authentication procedure request, at step 201;
(b) determining, at step 202, a confidence level associated with the authentication procedure;
(c) selecting, at step 204, an authentication process that matches the confidence level; and
(d) executing, at step 206, the authentication process.

As will be described below in further detail, the step, 202, of determining the Confidence Level includes the steps of:
(a) receiving instructions to determine a confidence level;
(b) determining a confidence level by monitoring one or more of the following: sensor data;
   (ii) user behaviour;
   (iii) payment history;
   (iv) security level;
   (v) connected devices; and
   (vi) location data; and
(c) returning said confidence level,

The confidence level represents a relative risk of fraudulent activity.

If the authentication was successful, at step 208, then the process 200 includes the step 210 of recording data on the successful authentication.

Further, the process 200 includes a check, at step 212, to see if there are any separate devices connected to the mobile device 10. Such devices may include:
(a) a wearable device such as a watch or a wristband;
(b) a medical device such as a heartrate monitor;
(c) a virtual reality headset; and
(d) Internet of Things (JOT) device.

Alternatively, the other device may be any other device connected to the mobile device 10 at that time.

If connection to a separate device is detected, at step 212, then the following processing steps are performed:
(a) recording, at step 214 details of the separate device; and
(b) Setting, at step 216, a “device connected” flag to “1”, “TRUE” or another non-null value.

The device 10 includes the following authentication processes:
(a) Iris authentication;
(b) Facial authentication;
(c) Voice authentication;
(d) Fingerprint authentication;
(e) Vein authentication; and
(f) Heartbeat authentication.

Individually, each of the above authentications processes is known in the art and specific operations are not described here in further detail. Of course, it is envisaged that the invention can be used with any other suitable authentication process that can be used with the mobile device 10.

Each authentication process used by the mobile device 10 includes an associated Confidence Level.

The Confidence Level is measured as a number, or a non-numerical value selectable from an ordered set of elements (such as {“low”, “medium”, “high”}), associated with the authentication procedure being effected. The Confidence Level may be a floating point number (positive, non-negative, non-positive or negative) or a counter. For example, the Confidence Level may be a probability.

### The Fraud Engine 118

As shown in FIG. 3, the Fraud Engine 118 is used to determine a Confidence Level of the authentication procedure. The Confidence Level is preferably a number which reflects the level of trust that should be associated with the procedure. The Fraud Engine 118 preferably performs the steps 400 shown in FIG. 4 to determine the Confidence Level.

The Fraud Engine 118 can be part of:
(a) the device Operating System;
(b) a Mobile Payment Application; or
(c) an independent fraud detection and/or prevention module which can be shared between different payment applications.

The processes executed by the Fraud Engine 118 are described below in further detail.

### Device Connected

The Engine 118 waits, at 402, for an authentication request. If an authentication request is received, at 402, then the Engine 118, at step 404, rests the Confidence Level to zero or other null value.

The Engine 118 then checks, at 406, to see if the “device connected” flag has been set. As will be described in further detail below, this flag is set where:
(a) a separate device is connected to the mobile device 10, either wirelessly or by physical connection; and
(b) an authentication process has previously been successfully completed.

The separate device can be:
(a) a wearable device such as a watch or a wristband;
(b) a medical device such as a heartrate monitor;
(c) a virtual reality headset; and
(d) Internet of Things (IOT) device.

Alternatively, the separate device may be any other device connected to the mobile device 10 at that time.

The additional devices can provide additional authentication ways and can help with Confidence Level.

In the event that the flag has been set, then the Engine 118 checks, at 408, to see if the device currently connected to the mobile device 10 is the same as the one that set the flag. If so, then the Engine 118 checks, at step 410, the quality of the connection. If the quality of the connection is good, then the Engine 118 returns, at step 412, a value of Confidence Level=“High”. For example:

If a user is wearing a watch or a wrist band connected to the device whilst performing an In-App or e-commerce purchase, then the user is authenticated continually until the user disconnects the device. The confidence level in these transactions is high.

If a user is wearing a heartrate monitor connected to the device whilst performing an In-App or e-commerce purchase, then the user is authenticated continually until the user disconnects the device. The confidence level in these transactions is high.

If the user is wearing virtual reality head gear whilst performing an In-App or e-commerce purchase, then the user is authenticated continually until the user disconnects the device. The confidence level in these transactions is high.

If the quality of the connection is not good, then the Fraud Engine 118, at step 414, decrements the Confidence Level and continues its processing steps. Typically, devices are connected by Bluetooth™ low energy. A Bluetooth™ low energy connection loss or lower received signal strength indication (RSSI) can indicate the possible loss or misuse of the device 10.

Otherwise, if the device currently connected to the mobile device 10 is not the same as the one that set the flag, then the Fraud Engine 118 resets, at step 416, the “wearable device flag” to a zero or null value.

### Confidence Level Based on Geographical Location & Payment History

If the Fraud Engine 118 deems, at 418, that the authentication procedure is not associated with a purchase, then the Fraud Engine 118 returns, at step 420, the value of the Confidence Level.

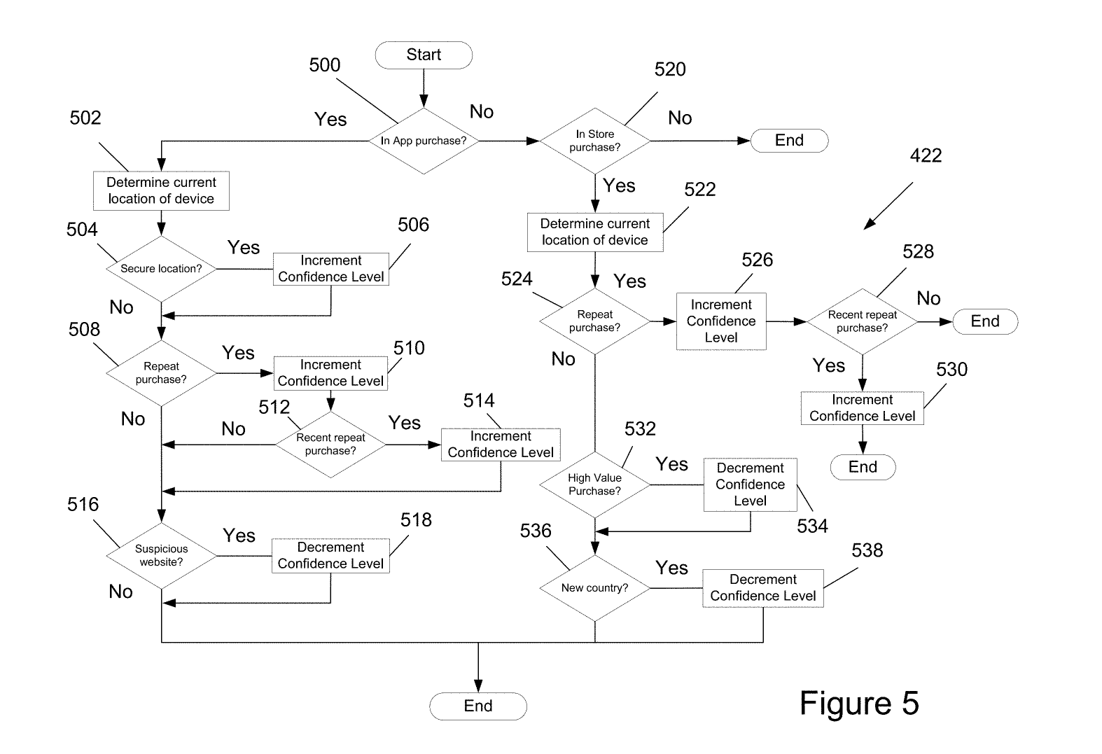

Otherwise, if the Fraud Engine 118 deems, at 418, that the authentication is associated with a purchase, then the Fraud Engine 118 executes the steps 422 shown in FIG. 5.

In-App or e-Commerce Purchase?

If the Fraud Engine 118 determines, at step 500, that the authentication is associated with an in-App purchase, then the Fraud Engine 118 generates, at step 502, the current location of the device 10 and determines, 504, if the current location falls within a set of secure locations. If so, then the Fraud Engine 118 increments, at step 506, the Confidence Level. For example, safe locations include:
(a) home address of the device owner;
(b) shipping address of device owner; and
(c) office address of device owner.

The mobile device 10 has the capability to determine its current location using:
(a) Global positioning system (GPS);
(b) Global navigation satellite system (GNSS);
(c) Baidu;
(d) network aiding including sensor data;
(e) Wifi connections; and
(f) Bluetooth™ low energy wireless network (BLE).

If the Fraud Engine 118 determines, at step 508, that the user has previously made a successful purchase with the same merchant, then the Fraud Engine 118 increments, at step 510, the Confidence Level. Further, the Fraud Engine 118 checks, at 512, to determine if the repeat purchase was recently made. If so, then the Fraud Engine 118 increments, at step 514, the Confidence Level.

A set of successful purchases/authentications is developed over time by recording details of each successful transaction, including:
(a) a location of merchant;
(b) high or low value transaction;
(c) name of merchant;
(d) date of purchase; and
(e) On Device Cardholder Verification Method (ODCVM) used.

The Fraud Engine 118 checks, at step 516, to see if the site where the purchase is being made is suspicious. If found to be suspicious, then the Fraud Engine 118 decrements, at step 518, the Confidence Level.

### In-Store Purchase?

If the Fraud Engine 118 determined, at step 500, that the purchase was not an in-App purchase, and the Fraud Engine 118 determines, at 520, that the purchase is an in-store purchase, then the Fraud Engine, at step 522, generates the current location of the device 10. If the Fraud Engine 118 determines, at step 524, that the user has previously made a successful purchase with the same merchant, then the Fraud Engine 118 increments, at step 526, the Confidence Level counter. Further, the Fraud Engine 118 checks, at 528, to determine if the repeat purchase was recently made. For example, if the purchase was made with in the last 10 minutes. If so, then the Fraud Engine increments, at step 530, the Confidence Level.

As above-mentioned, a set of successful purchases/authentications is developed over time by recording details of each successful transaction, including:
(a) a location of merchant;
(b) high or low value transaction;
(c) name of merchant;
(d) date of purchase; and
(e) On Device Cardholder Verification Method (ODCVM) used.

The Fraud Engine 118 checks, at step 532, to see if the purchase is high value. For example, if the purchase price is greater than $1000. If so, then the Fraud Engine 118 decrements, at step 534, the Confidence Level.

The Fraud Engine 118 checks, at step 536, to see if the country where the purchase is being made is new. If so, then the Fraud Engine 118 decrements, at step 538, the Confidence Level.

### Security Level & User Behaviour

Different configurations on the mobile device 10 exist (Device Identification), including:
(a) Universal Integrated Circuit Card (UICC), Embedded Secure Element (ESE) or Host Card Emulation (HCE):
(b) Mobile Payment Application (MPA) security is APP level or Device level (depending on the architecture):
(c) Authentications available on the device:
(d) Last Device Unlock Status and the Authentication method used.

User behavior can also be tracked, such as:
(a) Visiting suspicious websites;
(b) Not following the normal behavior of access email/calls/messaging or other APP usage; and
(c) Change in spending behavior.

All such data can help in determining the ODCVM priority, Confidence Level and access type.

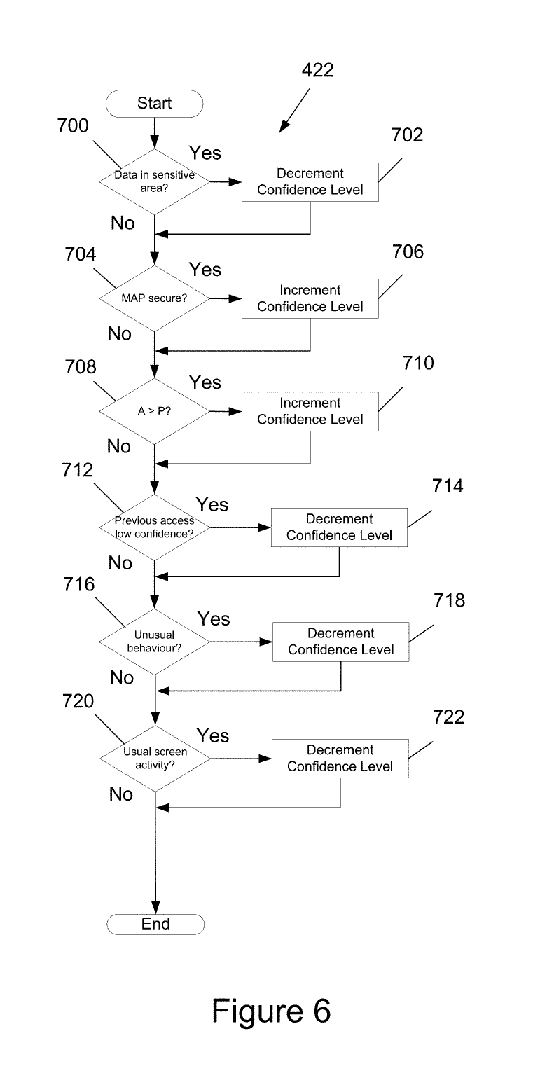

As shown in FIG. 6, the Fraud Engine 118 determines, at step 700, if the relevant data resides in a sensitive area on the device 10. If so, then the Fraud Engine 118 decrements, at step 702, the Confidence Level.

The Fraud Engine 118 determines, at step 704, how secure the Mobile Payment Application is. If so the MPA is secure, then the Fraud Engine 118 increments, at step 706, the Confidence Level.

The Fraud Engine 118 determines, at step 708, the number “A” of authentication methods that are available on the device 10. If “A” is greater than a predetermined number “P”, such as 6, then the Fraud Engine 118 increments, at step 710, the Confidence Level.

The Fraud Engine 118 also keeps track of the last device unlock status and the authentication method used. If the last authentication method used had an associated low Confidence Level, at step 712, then the Fraud Engine 118 decrements, at step 714, the Confidence Level.

Advantageously, the Fraud Engine 118 also monitors, at step 716, other user behaviour to assist in determining Confidence Level. For example, the Fraud Engine 118 determines whether the user is not following the normal behavior of access email/calls/messaging or other APP usage. In such circumstances, the Confidence Level is decremented, at step 718. Similarly, the Fraud Engine 118 determines, at step 720, whether the user is performing unusual touch on the screens or invalid activities on the screen (for example, Mobile device kept in pocket or a child using the Mobile device). If unusual activity is determined, then the Confidence Level is decremented, at step 722.

### Past Authentication Challenge Output

The Fraud Engine 118 is able to use the benefit of past authentication challenges to influence the Confidence Level. For example, while taking fingerprint, due to dirt or moisture, the prints are not clear. The matching score would be low or no sufficient matching points will be available. Possible output scenario:
(a) No-match Match;
(b) Detected with liveness;
(c) Match detected with no-liveness; and
(d) Indecisive due to limitation of environment or technology.

In case the outcome is indecisive (result (d)), the Fraud Engine 118 might set the Confidence Level to “Low”.

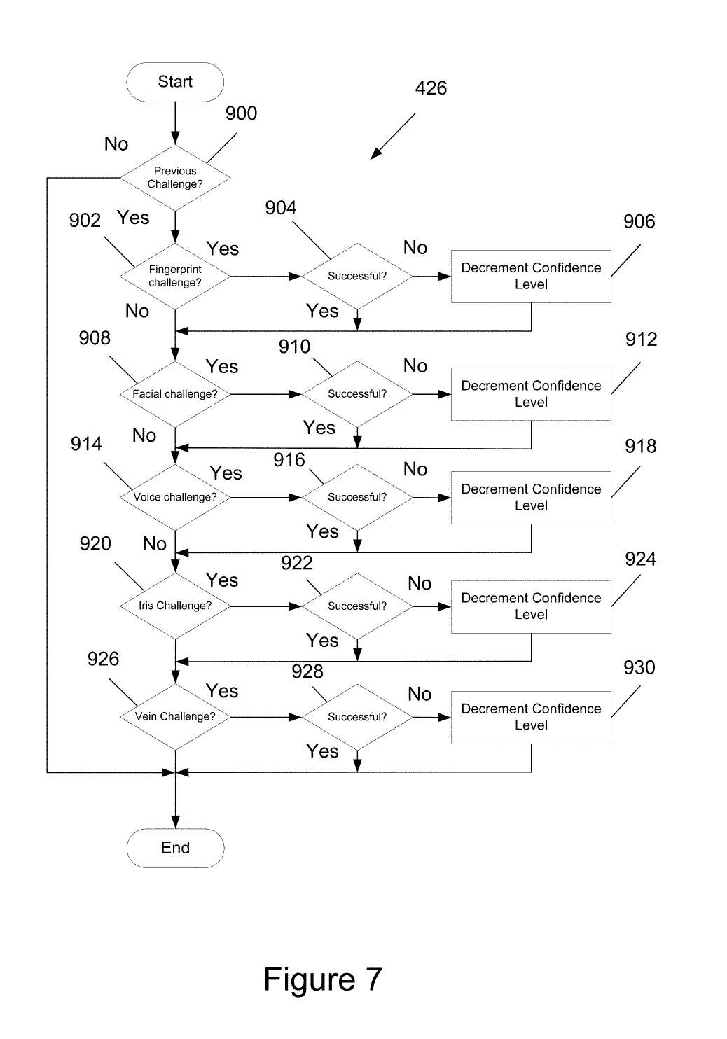

In view of the above, the Fraud Engine 118 executes the process 426 shown in FIG. 7 to influence the Confidence Level of the authentication processes. The Fraud Engine 118 checks, at step 900, if a previous authentication challenge has been effected. If not, then the Fraud Engine 118 returns to the process 400. Otherwise, the Fraud Engine 118 runs through the following routine:

The Fraud Engine 118 checks, at step 902, to see if Fingerprint authentication had previously been used. If used, then the Fraud Engine checks, at step 904, to see if it was used successfully and, if so, then the Fraud Engine 118 decrements, at step 906, the Confidence Level.

The Fraud Engine 118 checks, at step 908, to see if Facial authentication had previously been used. If used, then the Fraud Engine checks, at step 910, to see if it was used successfully and, if so, then the Fraud Engine 118 decrements, at step 912, the Confidence Level.

The Fraud Engine 118 checks, at step 914, to see if Voice authentication had previously been used. If used, then the Fraud Engine 118 checks, at step 916, to see if it was used successfully and, if so, then the Fraud Engine 118 decrements, at step 918, the Confidence Level.

The Fraud Engine 118 checks, at step 920, to see if Iris authentication had previously been used. If used, then the Fraud Engine checks, at step 922, to see if it was used successfully and, if so, then the Fraud Engine 118 decrements, at step 924, the Confidence Level.

The Fraud Engine 118 checks, at step 926, to see if Vein authentication had previously been used. If used, then the Fraud Engine checks, at step 928, to see if it was used successfully and, if so, then the Fraud Engine 118 decrements, at step 930, the Confidence Level.

### Networks

The Confidence Level generated by the Fraud Engine 118 can be fed into a network as additional data along with the transaction details. Low Confidence Level data can help a network to either decline the transaction or to send a request for additional authentication from the user.

Many modifications will be apparent to those skilled in the art without departing from the scope of the present invention.

The reference to any prior art in this specification is not, and should not be taken as, an acknowledgment or any form of suggestion that the prior art forms part of the common general knowledge.

In this specification and the claims that follow, unless stated otherwise, the word “comprise” and its variations, such as “comprises” and “comprising”, imply the inclusion of a stated integer, step, or group of integers or steps, but not the exclusion of any other integer or step or group of integers or steps.

References in this specification to any prior publication, information derived from any said prior publication, or any known matter are not and should not be taken as an acknowledgement, admission or suggestion that said prior publication, or any information derived from this prior publication or known matter forms part of the common general knowledge in the field of endeavour to which the specification relates.

1. A computer device for monitoring for fraudulent activity, including:
(a) a plurality of sensors; and
(b) one or more processors in communication with the sensors and non-transitory data storage including, stored thereon, a plurality of instructions which, when executed, cause the one or more processors to perform the steps of:
(i) receiving instructions to determine a confidence level;
(ii) determining a confidence level by monitoring one or more of the following:
sensor data;
user behaviour;
payment history;
security level;
connected devices; and
location data; and
(iii) returning said confidence level,
wherein the confidence level represents a relative risk of fraudulent activity.

2. The device claimed in claim 1, wherein the monitoring of the connected devices includes the determining if a separate device is in communication with the computer device, then decrementing the confidence level if there is a reduction of the quality of the signals received from the separate device.

3. The device claimed in claim 2, wherein a reduction of the quality of the signals received from the separate device is determined if the signal strength falls below a threshold.

4. The device claimed in claim 1, wherein the monitoring of the user behaviour includes decrementing the confidence level if the user is not following predefined behaviour patterns.

5. The device claimed in claim 4, wherein the predefined behaviour patterns include patterns associated with one or more of the following:
(a) accessing e-mail;
(b) accessing calls;
(c) accessing messages;
(d) touch on a screen of the device; and
(e) activities on the device.

6. The device claimed in claim 1, wherein the monitoring of the security level includes incrementing the confidence level if data is accessed from a secure area on the computer device.

7. The device claimed in claim 1, wherein the monitoring of the security level includes decrementing the confidence level if a mobile payment application being used by the computer device is not secure.

8. The device claimed in claim 1, wherein the monitoring of the location data includes:
(a) if the computer device is being used with an authentication procedure for a purchase, then the monitoring of the location data includes determining if the authentication procedure is being effected in or from a secure location and, if so, incrementing the confidence level.

9. The device claimed in claim 8, wherein if the purchase is an in App-or e-commerce purchase, then the confidence level is decremented if the procedure is being used with a suspicious web site.

10. The device claimed claim 1, wherein the monitoring of the payment history includes:
(a) if the computer device is being used with an authentication procedure for a purchase, then the monitoring of the payment history includes determining if the purchase is a repeat purchase and, if so, incrementing the confidence level.

11. The device claimed in claim 10, wherein the confidence level is incremented again if the procedure relates to a recent repeat purchase within a predetermined time interval from the purchase.

12. The device claimed in claim 8, wherein the confidence level is decremented if the purchase is high value.

13. The device claimed in claim 10, wherein the confidence level is decremented if the purchase is high value.

14. The device claimed in claim 8, wherein the confidence level is decremented if the purchase is being effected in a country in which the computer device has not previously been used to effect a purchase.

15. The device claimed in claim 10, wherein the confidence level is decremented if the purchase is being effected in a country in which the computer device has not previously been used to effect a purchase.

16. A method for monitoring for fraudulent activity on a computer device, including:
(a) receiving an instruction to determine a confidence level;
(b) determining a confidence level by monitoring one or more of the following:
(i) sensor data;
(ii) user behaviour;
(iii) payment history;
(iv) security level;
(v) connected devices; and
(vi) location data; and
(c) returning said confidence level,
wherein the confidence level represents a relative risk of fraudulent activity.

17. The method claimed in claim 16, wherein the monitoring of the connected devices includes determining if a separate device is in communication with the computer device, then decrementing the confidence level if there is a reduction of the quality of the signals received from the separate device.

18. The method claimed in claim 17, wherein a reduction of the quality of the signals received from the separate device is determined if the signal strength falls below a threshold.

19. The method claimed in claim 16, wherein the monitoring of the user behaviour includes decrementing the confidence level if the user is not following predefined behaviour patterns.

20. The method claimed in claim 19, wherein the predefined behaviour patterns include patterns associated with one or more of the following:
(a) accessing e-mail;
(b) accessing calls;
(c) accessing messages;
(d) touch on a screen of the device; and
(e) activities on the device.

21. The method claimed in claim 16, wherein the monitoring of the security level includes incrementing the confidence level if data is accessed from a secure area on the computer device.

22. The method claimed in claim 16, wherein the monitoring of the security level includes decrementing the confidence level if a mobile payment application being used by the computer device is not secure.

23. The method claimed in claim 16, wherein the monitoring of the location data includes:
(a) if the computer device is being used with an authentication procedure for a purchase, then the monitoring of the location data includes determining if the authentication procedure is being effected in or from a secure location and, if so, incrementing the confidence level.

24. The method claimed in claim 23, wherein if the purchase is an in-App or e-commerce purchase, then the confidence level is decremented if the procedure is being used with a suspicious web site.

25. The method claimed in claim 16, wherein the monitoring of the payment history includes:
(a) if the computer device is being used with an authentication procedure for a purchase, then the monitoring of the payment history includes determining if the purchase is a repeat purchase and, if so, incrementing the confidence level.

26. The method claimed in claim 25, wherein the confidence level is incremented again if the procedure relates to a recent repeat purchase within a predetermined time interval from the purchase.

27. The method claimed in claim 23, wherein the confidence level is decremented if the purchase is high value.

28. The method claimed in claim 25, wherein the confidence level is decremented if the purchase is high value.

29. The method claimed in claim 23, wherein the confidence level is decremented if the purchase is being effected in a country in which the computer device has not previously been used to effect a purchase.

30. The method claimed in claim 25, wherein the confidence level is decremented if the purchase is being effected in a country in which the computer device has not previously been used to effect a purchase.

31.-68. (canceled)
